(19) United States
(12) Patent Application Publication
(10) Pub. No.: US 2014/0279538 A1
(43) Pub. Date: Sep. 18, 2014

(54) SYSTEMS, METHODS, AND DEVICES FOR VERIFYING A USER IDENTITY AND/OR ENABLING/DISABLING AN ACTION, USING A CURRENT AND/OR PREVIOUS USER LOCATION

(71) Applicant: Telcom Ventures, LLC, Miami, FL (US)

(72) Inventor: Rajendra Singh, Indian Creek Village, FL (US)

(73) Assignee: Telcom Ventures, LLC, Miami, FL (US)

(21) Appl. No.: 14/206,887

(22) Filed: Mar. 12, 2014

Related U.S. Application Data
(60) Provisional application No. 61/782,421, filed on Mar. 14, 2013.

(51) Int. Cl. H04W 4/02; G06Q 20/38; G06Q 20/32

(52) U.S. Cl. CPC H04W 4/028; G06Q 20/3224; G06Q 20/382
USPC 705/44

(57) ABSTRACT

Methods for enabling or disabling an electronic message or a financial transaction are provided. The methods may include enabling or disabling the electronic message or the financial transaction based on whether a current or previous physical location of a wireless user device corresponds to a specified location. Related wireless user devices, servers, and third-party devices are also described.

### CLAIM OF PRIORITY

The present application claims the benefit of U.S. Provisional Patent Application Ser. No. 61/782,421, filed Mar. 14, 2013, entitled Systems, Methods, and Devices for Verging a User Identity and/or Enabling/Disabling an Action, Using a Current and/or Previous User Location, the disclosure of which is hereby incorporated herein in its entirety by reference.

### FIELD

The present disclosure relates to wireless communications systems, methods, and devices and, more particularly, to systems, methods, and devices that use a user location.

### BACKGROUND

Locations (e.g., positions) of wireless electronic devices may be determined using various techniques. For example, a User Equipment (UE) may determine its location using an integrated Global Positioning System (GPS) receiver. Accordingly, it may be possible to determine where a user of the UE is currently located, and/or where the user has previously been located, by tracking the location of the UE.

### SUMMARY

According to some embodiments, methods for enabling or disabling an electronic message or a financial transaction are provided. The methods may include accessing a history of previous physical locations of a wireless user device. Moreover, the methods may include enabling or disabling the electronic message or the financial transaction, in response to whether the history of previous physical locations of the wireless user device indicates that the wireless user device has been at a specified location. Wireless user devices, servers, or third-party devices, configured to perform the methods, may also be provided.

In some embodiments, enabling or disabling the electronic message or the financial transaction may include blocking access by the wireless user device to the electronic message, in response to whether the history of previous physical locations of the wireless user device indicates that the wireless user device has been at the specified location. Moreover, blocking access by the wireless user device to the electronic message may include blocking access to the electronic message, in response to determining that the history of previous physical locations of the wireless user device does not indicate that the wireless user device has been at the specified location.

In some embodiments, enabling or disabling the electronic message or the financial transaction may include granting access by the wireless user device to the electronic message, in response to determining that the history of previous physical locations of the wireless user device indicates that the wireless user device has been at the specified location. Moreover, enabling or disabling the electronic message or the financial transaction may include disabling the financial transaction by a digital wallet used by the wireless user device, and/or by a credit card, in response to determining that the wireless user device has not been at the specified location during a particular timeframe. The specified location may be a first location that is different from a second location of the wireless user device when it attempts the financial transaction.

In some embodiments, enabling or disabling the electronic message or the financial transaction may include enabling the financial transaction by a digital wallet used by the wireless user device, in response to determining that the wireless user device has been at the specified location during a particular timeframe. Enabling the financial transaction by the digital wallet used by the wireless user device may include enabling the financial transaction device only for a given time period, in response to determining that the wireless user device has been at the specified location during the particular timeframe.

In some embodiments, enabling or disabling the electronic message or the financial transaction may include enabling the electronic message or the financial transaction, in response to determining on a particular day that the wireless user device was at a home of a user of the wireless user device overnight and has been at a business location of the user of the wireless device on the particular day. Moreover, the electronic message may be encrypted based on the history of previous physical locations of the wireless user device, and the methods may include decoding the electronic message using the history of the previous physical locations of the wireless user device.

In some embodiments, keys corresponding to the electronic message may be conditioned upon permitted locations of the wireless user device. The methods may thus include blocking availability of the keys for decrypting the electronic message, in response to determining that the history of previous physical locations of the wireless user device does not match the permitted locations of the wireless user device.

Is some embodiments, the wireless user device may be a first wireless user device, the history of previous physical locations of the first wireless user device may be a first history, and enabling or disabling the electronic message or the financial transaction may include disabling communication of the electronic message between the first wireless user device and a second wireless user device, when a secure server or a third-party device mediating and/or initiating the communication does not have the first history of previous physical locations of the first wireless user device and a second history of previous physical locations of the second wireless user device.

According to some embodiments, methods for enabling or disabling a financial transaction are provided. The methods may include enabling or disabling the financial transaction in response to whether a current or previous physical location of a wireless user device corresponds to a permitted location. Moreover, enabling or disabling the financial transaction may include enabling the financial transaction in response to determining that a current or previous physical location of the wireless user device corresponds to the permitted location. Wireless user devices, servers, or third-party devices, configured to perform the methods, may also be provided.

According to some embodiments, methods for enabling or disabling an electronic message are provided. The methods may include enabling or disabling the electronic message in response to whether a current or previous physical location of a wireless user device corresponds to a permitted location. Moreover, enabling or disabling the electronic message may include enabling the electronic message in response to determining that a current or previous physical location of the wireless user device corresponds to the permitted location. Wireless user devices, servers, or third-party devices, configured to perform the methods, may also be provided.

### BRIEF DESCRIPTION OF THE DRAWINGS

FIG. 1 is a schematic diagram illustrating a geographical area that includes a user device, according to various embodiments described herein.

FIGS. 2-7 are flowcharts illustrating operations for verifying a user identity and/or enabling/disabling an action, using a current and/or previous user location, according to various embodiments described herein.

### DETAILED DESCRIPTION

Example embodiments of the present inventive concepts now will be described with reference to the accompanying drawings. The present inventive concepts may, however, be embodied in a variety of different forms and should not be construed as limited to the embodiments set forth herein. Rather, these embodiments are provided so that this disclosure will be thorough and complete, and will fully convey the scope of the present inventive concepts to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled or responsive.

The terminology used herein is for the purpose of describing particular embodiments of the present inventive concepts only and is not intended to be limiting of the present inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which the present inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

Operations provided herein describe enabling/disabling an action (e.g., a message or a purchase), and/or establishing/verifying an identity, using a current user device location and/or a previous user device location. For example, a message may be broadcast to a large group but received only by individuals at a particular location (e.g., the third floor of a building). In another example, use of a credit/debit card may be conditioned upon whether a user device has previously been (or has not previously been) at a particular location. In a further example, use of a user device to make a purchase may be conditioned upon whether the user device has previously been (or has not previously been) at a particular location. In yet another example, decryption of encrypted information may require knowledge of the location of the intended recipient.

Referring now to FIG. 1, a UE 101 is illustrated in a geographical area 102. The UE 101 may be (or may be a part of) one of various types of wireless electronic user devices (including mobile/cell phones, as well as wireless user devices without phone capabilities). The UE 101 can be located anywhere inside the geographical area 102. Although FIG. 1 illustrates a single UE 101, a plurality of UEs 101 may be located inside the geographical area 102. In some embodiments, hundreds, thousands, or more UEs 101 may be located inside the geographical area 102.

The UE 101 may wirelessly receive signals from transmitters such as a Base Station (BS)(e.g., a cellular BS) and/or from a Positioning Beacon (PB) of a Terrestrial Beacon Network (TBN). It will be understood that the geographical area 102 may include any number of (e.g., three, four, dozens, or more) BSs and/or PBs. Moreover, the UE 101 may receive signals from a Wi-Fi hot spot 121 in the geographical area 102 and/or a GPS network 174. Accordingly, it will be understood that the location (e.g., position) of the UE 101 may be determined using signals to/from the BSs, PBs, the Wi-Fi hot spot 121, and/or the GPS network 174.

In various embodiments of the present inventive concepts, an action may be enabled or disabled using the current location of a UE 101 or using a previous location (which may be determined using a history of user locations) of the UE 101. As an example, referring now to FIG. 2, a flowchart is provided that illustrates operations of enabling or disabling receipt of an electronic message. For example, for a team of detectives working on a case, information (e.g., in one of various types of electronic messages) may be transmitted/broadcast (Block 210) to the entire police force, but only received (Block 220) by the team (via their UEs 101) that is (or has been) at a particular location pertaining to the investigation. Moreover, the receipt (Block 220) of the information may be further restricted to a sub-team that is working (or has been working) on the case on the third floor of a particular building. Each UE 101 may be configured to collect such information, which can be stored at an Authorizing Server (AS) that can ensure that the broadcast information is only received by the sub-team of the police force that is working (or has been working) on the case. Accordingly, receipt of the information may be blocked for members of the police force outside of a particular team or sub-team. Such information may optionally be further protected by a password. Various embodiments of the present inventive concepts may thus provide operations of relatively simple distribution of information, combined with selective use/receipt of the information.

Referring now to FIGS. 3A and 3B, in another example of various embodiments of the present inventive concepts, use of a credit/debit card (Block 320) may be conditioned upon whether a user device has previously been (or has not previously been) at a particular location (which is distinct from being conditioned upon the contemporaneous/current location of the user device at the point of sale)(Block 310). For example, a parent may give a credit card or debit card to a teenager to purchase an item at a school or a bookstore. Various embodiments of the present inventive concepts may use the current location of the teenager's UE 101 to allow (Block 320A) the purchase of the item at the school (or at a business near the school) or at the bookstore. Additionally or alternatively, one or more purchases may be disallowed (e.g., disabled) based on a current or previous location of the teenager's UE 101. For example, the purchase of a movie ticket by a credit card (and/or a digital wallet used by the UE 101) may be disallowed (Block 320B) if the teenager has not been at a certain location (such as a school) that day (or in another timeframe). On the other hand, the purchase of the movie ticket may be allowed (Block 320A) if the teenager has been at the location that day. In another example, the use of a debit card may be disallowed (Block 320A′) at an Automated Teller Machine (ATM) that is near a liquor store (or other location). Such disablements of financial transactions using the current location or a previous location of the UE 101 may prevent/reduce impulse purchases of undesirable items by the teenager.

Referring now to FIG. 4, in a further example of various embodiments of the present inventive concepts, a relatively simple operation of purchasing an item using the UE 101 (e.g., using a digital wallet via the UE 101) is provided. If a user (e.g., owner) of the UE 101 has been at home and then wants to buy groceries at a grocery store, this purchase can be allowed (e.g., enabled)(Block 420A) by using a history of location information (which includes the previous location of the UE 101 at the home)(Block 410). For example, the user may be able to complete the purchase by lending the UE 101 to another person (e.g., a housekeeper), without sharing password information (or financial information) with the other person. Specifically, the user may lend the UE 101 to the other person, who can then go to the grocery store and purchase (Block 420A) items using the UE 101, because of authorization/verification provided based on the previous location of the UE 101 at the user's home. On the other hand, the purchase may be blocked (420B) if the UE 101 has not previously been at the user's home (or work, or another expected/historical location). Moreover, such use of the UE 101 to complete a financial transaction by a person other than the user may be limited to a given time period (e.g., thirty minutes, an hour, several hours, or more).

Referring now to FIG. 5, in yet another example of various embodiments of the present inventive concepts, a user's current location and/or a history of the user's previous locations may be used to verify the user's identity and/or enable one or more particular actions. The user's current location and/or history of previous locations may be referred to as Location Information (LI). For example, if (Block 510) the UE 101 has been at the location of the user's (e.g., owner's) home overnight, and is at the location of his/her workplace during the day, a reasonable assumption (Block 520) can be made that the UE 101 is located with that person. Accordingly, secure information may be sent to that person by encrypting the information based on the keys that are based on the LI (Block 530), which may be known to a secure server and/or the UE 101. On the other hand, if the UE 101 has not been at the user's home and/or workplace, then transmission/receipt of secure information may be blocked (Block 525). Moreover, even if the secure information is intercepted by a third party, it may be protected because it may only be decoded (Block 530) if the third party has knowledge of the LI.

Referring now to FIG. 6, in a further example, the keys (i.e., the actual keys themselves) may be based on (e.g., conditioned upon) location history. For example, if (Block 610) the location history of the UE 101 does not match with a permitted use (e.g., permitted locations), then the keys may not be available (Block 620B) to the UE 101 to decrypt information. On the other hand, if (Block 610) the location history of the UE 101 matches with a permitted use, then the keys may be available (Block 620A) to the UE 101 to decrypt information.

Referring now to FIG. 7, according to various embodiments of the present inventive concepts, a plurality of UEs 101 may have an action (e.g., a communication) enabled/disabled by a third party with LI history of the UEs 101. For example, two or more UE 101 owners may want to share (Block 720A) information (or otherwise communicate with each other). Such a communication may be mediated/initiated by a secure server that has LI history of the UEs 101, or by a third party with LI history of the UEs 101. On the other hand, the communication may be prevented (Block 720B) if (Block 710) the secure server or third party does not have the LI history.

A variety of different embodiments of the present inventive concepts have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present inventive concepts described herein, and of the manner and process of making and using them, and shall support claims to any such combination or subcombination.

In the drawings and specification, there have been disclosed example embodiments of the present inventive concepts. Although specific terms are employed, they are used in a generic and descriptive sense only and not for purposes of limitation, the scope of the present inventive concepts being defined by the following claims.

1. (canceled)

2. A method for enabling or disabling an electronic message or a financial transaction, the method comprising:
accessing a history of previous physical locations of a wireless user device; and
enabling or disabling the electronic message or the financial transaction, in response to whether the history of previous physical locations of the wireless user device indicates that the wireless user device has been at a specified location.

3. The method of claim 2, wherein enabling or disabling the electronic message or the financial transaction comprises blocking access by the wireless user device to the electronic message, in response to whether the history of previous physical locations of the wireless user device indicates that the wireless user device has been at the specified location.

4. The method of claim 3, wherein blocking access by the wireless user device to the electronic message comprises blocking access to the electronic message, in response to determining that the history of previous physical locations of the wireless user device does not indicate that the wireless user device has been at the specified location.

5. The method of claim 2, wherein enabling or disabling the electronic message or the financial transaction comprises granting access by the wireless user device to the electronic message, in response to determining that the history of previous physical locations of the wireless user device indicates that the wireless user device has been at the specified location.

6. The method of claim 2, wherein enabling or disabling the electronic message or the financial transaction comprises disabling the financial transaction by a digital wallet used by the wireless user device, and/or by a credit card, in response to determining that the wireless user device has not been at the specified location during a particular timeframe.

7. The method of claim 6, wherein the specified location comprises a first location that is different from a second location of the wireless user device when attempting the financial transaction.

8. The method of claim 2, wherein enabling or disabling the electronic message or the financial transaction comprises enabling the financial transaction by a digital wallet used by the wireless user device, in response to determining that the wireless user device has been at the specified location during a particular timeframe.

9. The method of claim 8, wherein enabling the financial transaction by the digital wallet used by the wireless user device comprises enabling the financial transaction device only for a given time period, in response to determining that the wireless user device has been at the specified location during the particular timeframe.

10. The method of claim 2, wherein enabling or disabling the electronic message or the financial transaction comprises enabling the electronic message or the financial transaction, in response to determining on a particular day that the wireless user device was at a home of a user of the wireless user device overnight and has been at a business location of the user of the wireless device on the particular day.

11. The method of claim 2, wherein the electronic message is encrypted based on the history of previous physical locations of the wireless user device.

12. The method of claim 11, further comprising decoding the electronic message using the history of previous physical locations of the wireless user device.

13. The method of claim 2, wherein keys corresponding to the electronic message are conditioned upon permitted locations of the wireless user device.

14. The method of claim 13, further comprising blocking availability of the keys for decrypting the electronic message, in response to determining that the history of previous physical locations of the wireless user device does not match the permitted locations of the wireless user device.

15. The method of claim 2,
wherein the wireless user device comprises a first wireless user device,
wherein the history of previous physical locations of the first wireless user device comprises a first history, and
wherein enabling or disabling the electronic message or the financial transaction comprises disabling communication of the electronic message between the first wireless user device and a second wireless user device, when a secure server or a third-party device mediating and/or initiating the communication does not have the first history of previous physical locations of the first wireless user device and a second history of previous physical locations of the second wireless user device.

16. The wireless user device, configured to perform the method of claim 2.

17. A server or a third-party device configured to perform the method of claim 2.

18. A method for enabling or disabling a financial transaction, the method comprising:
enabling or disabling the financial transaction in response to whether a current or previous physical location of a wireless user device corresponds to a permitted location.

19. The method of claim 18, wherein enabling or disabling the financial transaction comprises enabling the financial transaction in response to determining that the current or previous physical location of the wireless user device corresponds to the permitted location.

20. The wireless user device, configured to perform the method of claim 18.

21. A server or a third-party device configured to perform the method of claim 18.

22. A method for enabling or disabling an electronic message, the method comprising:
enabling or disabling the electronic message in response to whether a current or previous physical location of a wireless user device corresponds to a permitted location.

23. The method of claim 22, wherein enabling or disabling the electronic message comprises enabling the electronic message in response to determining that the current or previous physical location of the wireless user device corresponds to the permitted location.

24. The wireless user device, configured to perform the method of claim 22.

25. A server or a third-party device configured to perform the method of claim 22.
